(19) United States
(12) Patent Application Publication
(10) Pub. No.: US 2011/0222081 A1
(43) Pub. Date: Sep. 15, 2011

(54) Printing Three-Dimensional Objects Using Hybrid Format Data

(76) Inventors: Chen Yi, Boxborough, MA (US); Ivan Hee Yiu Ma, San Mateo, CA (US); Yecheng Wu, Lexington, MA (US)

(21) Appl. No.: 12/724,299

(22) Filed: Mar. 15, 2010

(51) Int. Cl. H04N 1/60; G06T 15/00

(52) U.S. Cl. 358/1.9; 345/419

(57) ABSTRACT

Methods of how to build a 3D model with both surface features and internal structures are disclosed. 3D image data in a hybrid data format or other suitable data formats are first received as input and then broken down into layers of 2D data. The layers of 2D data hold various attribute information about the model, such as colors, shapes, durometer hardness, etc. The layers of data are printed on printing sheets that are specially formulated. Selected materials are also deposited on printed sheets as dictated by the 2D data. Each printed sheet is cut along the shape boundaries either before or after it has been bound to previously printed sheets. Finished sheets are then bound and processed to generate a 3D model with rich details.

### BACKGROUND

Over the past decade or so, a range of 3D printing techniques have emerged. They include Fused Deposition Modeling (FDM), Inkjet Deposition (IJ), Layered Object Manufacturing (LOM), Inkjet Binding (IB), Selective Laser Sintering (SLS), Laser Powder Forming (LPF), Solid Ground Curing (SGC), Electron Beam Melting (EBM) and Stereo-lithography (SLA).

However, current 3D printing techniques all require vector format data as input. Data of a three-dimensional object can be represented in two basic formats: vector format or raster format. Vector format data use lines, polygons, parametric curves and surfaces to describe the geometric size and shape of an object. Examples of vector format data are IGES, STL, DXF, etc., which are often referred to as CAD (Computer Aided Design) data. CAD data typically store information of a 3D model as a collection of surface elements, such as triangles, polygons or parametric surface patches and include mostly geometric shape information.

Existing 3D printing devices use vector format CAD data to generate 3D models. When used to print 3D models, CAD data can yield models with accurate geometric surface features. But CAD data are not sufficient when the need is to generate models with internal features or structures.

Raster format data use voxels and pixels to describe the surface and interior structures of an object. A voxel, a blend of the words volumetric and pixel, represents a volumetric unit in a 3D coordinate system, such as a Cartesian coordinate system. Medical scan data such as those from CT (computed tomography) scanning, MRI (magnetic resonance imaging), or PET (positron emission tomography) are examples of raster format data. Scientists, researchers, radiologists, doctors, and surgeons regularly use raster format 3D image data such as CT scanning, MRI, or PET data to examine or study internal structures of human bodies, organisms or artifacts.

Printing 3D models that have both surface features and internal structures requires a data format that incorporates both information on surface geometric features and that on internal structures. Such data format is a hybrid between vector and raster format and may be generated from 3D images by extracting from the images both vector and raster data elements. Such data format may be used to represent surface features such as size and shape as well as internal structures such as color, density, durometer hardness of the object.

A hybrid data format is a 3D data format that defines an object by attributes that are more than just surface polygons and that may include internal structural details, such as color, density, discernable regions, durometer hardness, etc.

Assembly format CAD data files generated by various 3D modeling software, an example of which is an .asm file of the ProEngineer software, are a form of hybrid data format—that is, an assembly type CAD file consists of multiple vector format models that are connected through 3D space coordinates and constraints relationships. Traditionally, such assembly format data are used only for graphic presentations on two-dimensional computer screens or monitors. Some of the current 3D printing devices can take the vector data elements of a hybrid model data as input for 3D printing. But specialized 3D imaging software is required to convert the raster format image or the assembly format data into vector format data by extracting information on surface elements such as triangles, polygons or parametric surface patches for 3D printing. Current 3D printers can generate 3D objects with surface features but without internal structures or properties, such as varying density, parts with different properties, multiple parts, durometer hardness and colors, information of which are already provided by the hybrid format model data but are not used by current 3D printers.

A new or improved 3D printing system is needed to take advantage of the rich information provided by hybrid format data. Compared to CAD data, hybrid format data contain not only information on surface features but also detailed information on internal features or complex structures, for example, a structure of multiple distinct objects that are interconnected together. The internal features may include colors, density, and durometer hardness or other properties. Existing 3D printers are capable of printing multiple objects in one build. But the multiple objects are generated as separate entities. Each entity is made of the same material and has an identical internal color, density and durometer. The surface of the entity either has the same color as the internal body or is later painted with different colors. These entities may have to be pieced together after the 3D printing processes.

In the medical imaging field, 3D image scans are in raster format and are used to aid patient diagnosis and treatment. 3D models built from the 3D image scan data can provide further assistance to physicians in patient diagnosis and treatment.

Current 3D printers can not use 3D medical scan image data as input because those image data are in raster format. The 3D image data needs to be converted into vector format prior to being used in existing 3D printers. In the conversion process, internal structural information such as those represented by tissue colors or durometer hardness is inevitably lost.

The following are some of the existing patents or patent applications on 3D printing technologies.

Two of the existing 3D printing methods, Inkjet Binding and Layered Object Manufacturing methods are capable of building models with limited color applications. (See U.S. patent application Ser. No. 10/683,792; U.S. Pat. Nos. 6,506,477 and 6,007,318.) Although these systems are capable of applying colors at the surface of a model or treat the model as solid block with a single color, they can not create a 3D model with internal structures of varying colors.

U.S. Pat. No. 6,007,318 discloses a method of building a three-dimensional model by depositing powder type material. However, models built by such methods have uniform durometer hardness throughout. Similar to the previous methods, this method also can only generate colors at the surface of a model or treat the model as a solid block with a single color.

U.S. patent application Ser. No. 10/683,792 discloses a method of using water soluble to break away all supporting or excessive materials to create a 3D model. The toxic materials, such as the hardener and resin used as disclosed in that patent application present safety issues that render the method undesirable for use in hospitals or medical facilities. These safety issues may require special clothing and/or separate processing facilities to prevent, for example, skin contact or inhalation of toxic materials. Additional expenses may be required in order to comply with regulations on disposals of toxic materials.

U.S. Pat. No. 6,007,318 discloses a laser cutting method that can be used in a laminated object manufacturing (LOM) system. The laser cutting method is expensive. Fumes generated in the laser cutting process may require an air venting system. The cutting itself also adds time to the whole process and slows down the building time.

U.S. Pat. No. 6,506,477 discloses a method of building 3D models by laying sheets of material that are cut out into pre-defined shapes by knife. Such method solves the fume problem associated with laser cutting method. But cutting each sheet of material with knife takes considerable amount of time.

There is a need for an improved 3D printing system that overcomes the limitations of the existing 3D printing systems or methods. There is also a need for an improved 3D printing system that can build 3D models economically and efficiently and can generate 3D models with both surface features and internal structures.

### SUMMARY

In a general aspect, the invention features a method of building a 3D model. The method includes the following steps. First 3D image data of a 3D object are received as input. Second the image data are broken down into two or more layers of data. Each layer of data includes attribute information such as color, durometer hardness or other mechanical properties about the object. Each layer of data is printed on a printing sheet and one or more special materials are deposited on the printed sheet according to the attribute information contained in the layer of data. Afterward one or more steps of preparation, each printed sheet is bound and pressed into a finished stack. The printed sheet is then cut along the shape boundaries or predefined regions. The above process continues until the last layer of data has been printed. The finished stack is then shaped into a 3D model by removing materials along the cutting edges. This aspect of the invention can include one or more of the following features. First the 3D image data may be in a hybrid data format that may include either voxel data or geometrical shape data or both. In some implementations, before the 3D image data is broken down into layers of data, information on the material properties of the printing sheets and the special materials selected for creating varying durometer hardness and for binding purposes may be used to calculate the desired number of layers. In some implementations the one or more selected materials include a type of repositionable adhesive which will allow the 3D model to be easily dissembled and reassembled. The printing sheet may also be made of magnetic film or be covered with a magnetic coating for easy dissembling and reassembling of the 3D model. Mechanical methods, such as clip binder and screws can also be used to hold the 3D model together. In some implementations, layers of data are printed on printing sheets with florescent inks.

In some implementations, the selected materials may or may not be mixed before being deposited onto the printed sheet. In some implementations, before being bound and pressed into the finished stack, the printed sheet may be collated and assembled, and/or may be given time to allow the materials deposited on the printed sheet to cure. In some implementations, curing may he achieved through the use of a heated roller by press the printed sheet onto the finished stack, while in other implementations curing may be achieved through UV exposure.

In a second aspect, the invention features a 3D printing apparatus that can be used to build a 3D model. The 3D printing apparatus generally includes a data processing module for processing image data of the 3D model and for breaking down the image data into processed data of two or more layers with the image data being a 3D image of the 3D model; a system controlling module for controlling the 3D printing apparatus; a media cartridge for holding printing sheets; a building module for printing, preparing, assembling, and binding printed sheets into a stack and for finishing the 3D model after the stack is completed.

The second aspect of the invention can include one or more of the following features. In some implementations, the 3D printing apparatus may further include an information storage device to store information about the media cartridge. In some implementations, the stored information about the media cartridge may include the size information of the printing sheets currently stored in the media cartridge. In some implementations, the building module may include a printer for printing the processed data of the two or more layers onto the printing sheet. The building module may further comprise a mechanism to transfer printing sheets from the media cartridge to the building module. The building module may also comprise a working platform to hold the 3D model while it is being built, in which case, the position of the working platform may be controlled by a distance sensing device.

In some implementations, the building module may comprise a dispensing mechanism for depositing one or more selected materials onto printing or printed sheets to yield different durometer hardness. The selected materials may be epoxies or solvent-resistant ink.

In some implementations, the building module may further comprise a cutting mechanism for cutting though boundaries of a 3D image. Alternatively, the building module may comprise a solvent dispense mechanism for dispensing solvent to remove parts of the printed sheet on which the solvent-resistant ink has not been deposited.

In a third aspect, the invention features a 3D object builder for building complex objects derived from 3D hybrid data. The 3D object builder includes (a) a media holder that includes a plurality of media, a media holding feature, a memory device wherein the memory device includes data regarding media details and security and wherein said media are of uniform dimensions; (b) a mechanical mechanism that moves media from the media holder to a work area (c) a means to implement a plurality of colors at each volumetric location of the 3D object while the media is in the work area, wherein the means to implement a plurality of colors is a typical color printing method attached to a 3D object builder such that the printer may deposit a plurality of color at each volumetric location in the 3D object that is being printed; (e) a means to implement a plurality of durometer hardness at each volumetric location of the 3D object while the media is in the work area, wherein the means to implement a plurality of said durometer hardness include materials in conjunction with chemical, curing and heating means; and (f) a means to build one or more objects within the 3D object derived from said native hybrid data wherein the means to implement a plurality of objects derived from said data files is by distinguishing regions in each cross sectional layer of the 3D object and separating each of said regions in each cross section during the 3D object building process where the thickness of said cross sectional layer is dependent on the thickness of the media used to build the 3d object.

This present invention has advantages over the existing technologies in many ways. For example, the methods of building 3D models disclosed in this application are much faster, more scalable and versatile. The models built using the methods disclosed in this application can have internal structures and internal colored features as well surface features. Those features and structures can be colored to resemble live objects or real-life models. Safe and non-toxic materials or techniques can be used in the apparatuses of this invention so that these apparatuses can be safely deployed in hospitals or medical facilities.

### DESCRIPTION OF DRAWINGS

FIG. 1 illustrates a first embodiment of a 3D printing apparatus.

FIG. 2 illustrates a second embodiment of the 3D printing apparatus.

FIG. 3 is a flow diagram of the printing process employed in the first embodiment.

FIG. 4 is a flow diagram of the 3D printing process employed in the second embodiment.

FIG. 5 illustrates different geometric elements in a 3D printing process.

FIGS. 6a and 6b show image layers that are divided into voxels.

FIG. 7 illustrates a method of achieving varying durometer hardness in different regions.

FIG. 8 is a flow diagram showing how to calculate the total number of sheets before breaking down the image data into layers.

FIG. 9a shows an image broken down into layers of uniform thickness.

FIG. 9b shows an image broken down into layers of non-uniform thickness.

FIG. 10 illustrates the geometric elements of a finished 3D object.

### DETAILED DESCRIPTIONS

The technology disclosed herein relates to three dimensional (3D) printing methods and apparatuses. More specifically, the present disclosure relates to the methods, processes and techniques that can be used to print or generate 3D models having both surface and internal features of varying attributes such as color, transparency, density, durometer hardness, elasticity, toughness, strength, and other mechanical properties.

One goal of the present new and innovative 3D printing system is to utilize the portion of the 3D image data that are ignored by current 3D printing systems and to generate 3D models with both surface features and internal structures. For instance, after a CT scan of a human torso, the hybrid format model data of that scan can be derived and sent directly to the new 3D printing system. Based on the data, the new 3D printing system can build a 3D model of the human torso with internal organs, for example, the lung and heart. Those internal organs can also be made removable. A physician can cut a cross section through the lung and visually examine the inside of the lung for scars, lesions or cancerous growth.

Medical application is just one example of many uses of our new and innovative 3D printing systems. It will become obvious to those skilled in the arts that this new technology holds advantages over current 3D printers in countless other applications such as rapid prototyping, composite material printing, search and rescue, archeological research, geology research, topography and the like.

In this disclosure, hybrid format data are used. Hybrid format refers to a type of data files that include color, transparency, shape, durometer hardness and other interior and exterior attributes of a 3D object. Although hybrid format data are not required and other data formats such as vector-based or raster-based data can be used, the invention presented has the unique benefit of using the hybrid format data to create a 3D model with accurate geometrical shape and rich interior and exterior features.

In the following sections, different 3D printer embodiments, modules of those printing apparatuses, and the basic operations of the 3D model building processes are discussed in detail.

### (1) First Embodiment

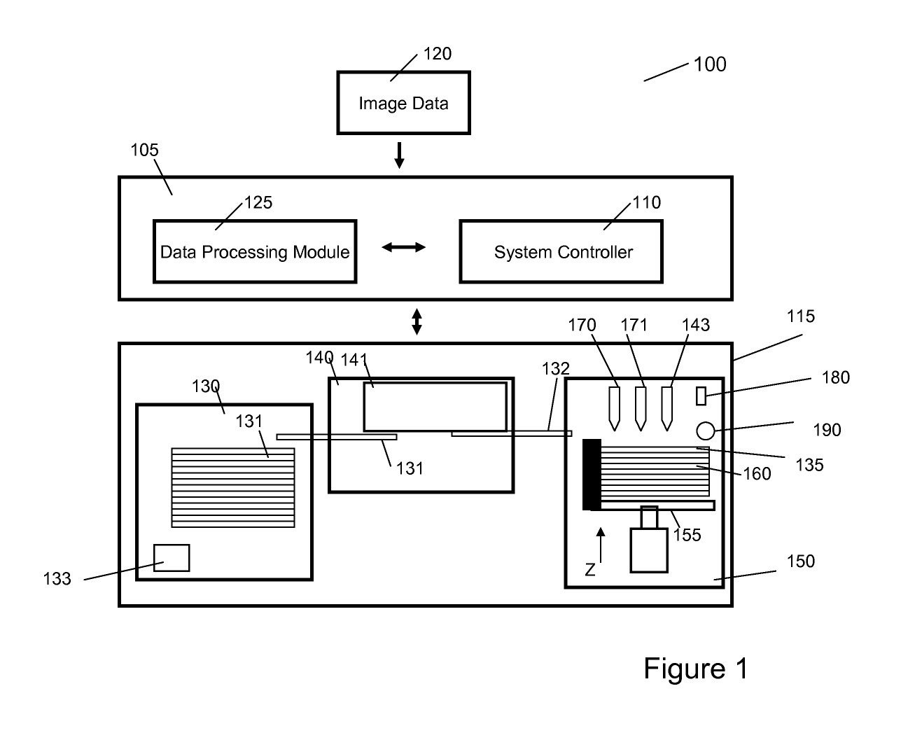

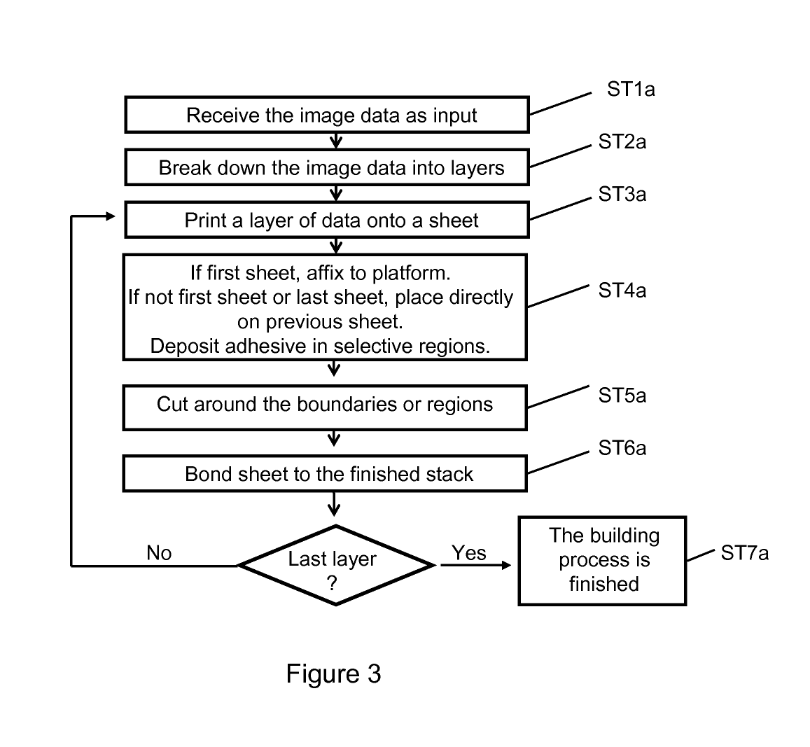

FIG. 1 illustrates a first embodiment of the 3D printing apparatus in accordance with the innovative 3D model building technologies disclosed herein. The 3D printing apparatus as shown in FIG. 1 comprises of a computer 105 and a building module 115. FIG. 3 is a flow chart showing the basic operations that are carried out in this particular embodiment.

a) Overview

In referring to FIG. 1, the computer 105 is a general computer system or any equivalent device that may include a display, a memory unit, a CPU, a hard drive, I/O ports, network ports and other parts or units. The computer 105 is divided into a system controller 110 and a data processing module 125. The computer 105 controls the operations of the building module 115.

FIG. 3 illustrates the basic operations carried out in the 3D model building process. In Step ST1a, the image data 120 is received and is forwarded to the data processing module 125 by the system controller 110. In Step ST2a, the image data which may be in hybrid format are broken down into multiple layers. This step is executed by the data processing module 125. In Step ST3a, each layer of data is printed on a sheet of printing material with color and other attributes. In step ST4a, the first sheet is affixed to the stack either via a vacuum mechanism or adhesive. Also in Step ST4a, a layer of adhesive is applied to pre-defined region(s) on the sheet. In Step ST5a, a cutting device may be used to cut through the boundary(ies) of region(s) to isolate the region(s). The cutting device can be a knife or a laser, or other equivalent devices. After the first sheet, all subsequent sheets are stacked onto the previous sheets with careful alignment. As each new sheet is stacked, adhesive is applied and boundaries around the pre-defined regions are cut. Depending on a particular implementation, additional steps such as heating, bonding, pressing may be carried out in Step ST6a. After Step ST6a, if no more layers of data need to be printed, the model is finished. Otherwise, the model building process goes back to Step ST3a and starts building the next layer.

b) Data Processing

As shown in FIG. 1, a 3D printing apparatus receives the image data 120 as input. Input data can be 3D images from CT (computed tomography) scanning, MRI (magnetic resonance imaging), or hybrid format model data that are derived from those CT data, MRI data, or CAD model data (such as those contained in .asm, .stl, .igs, .dxf files).

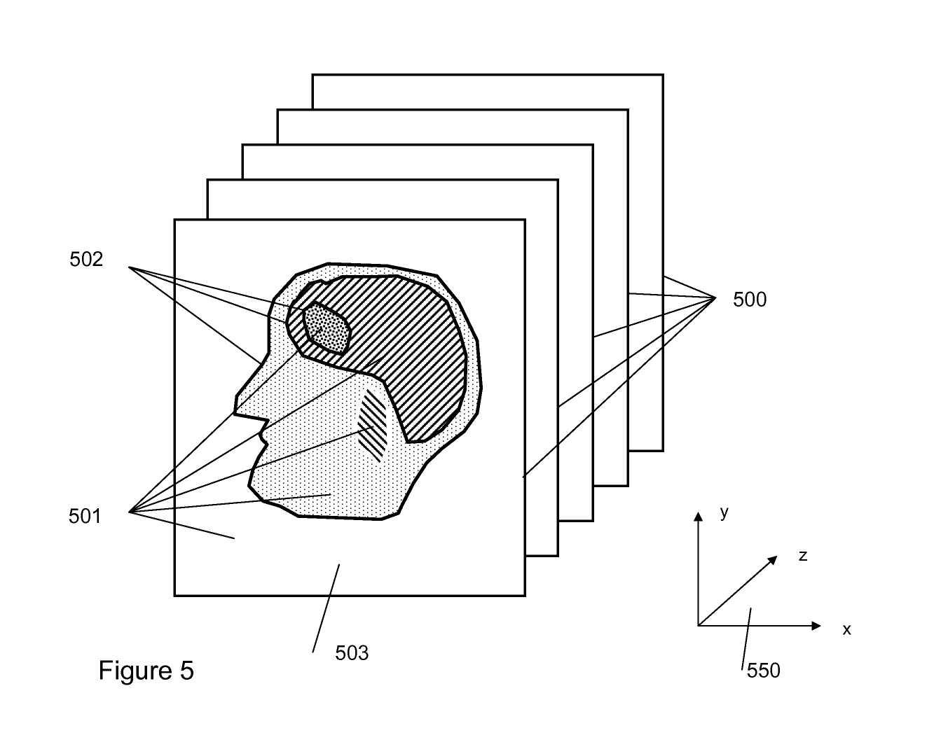

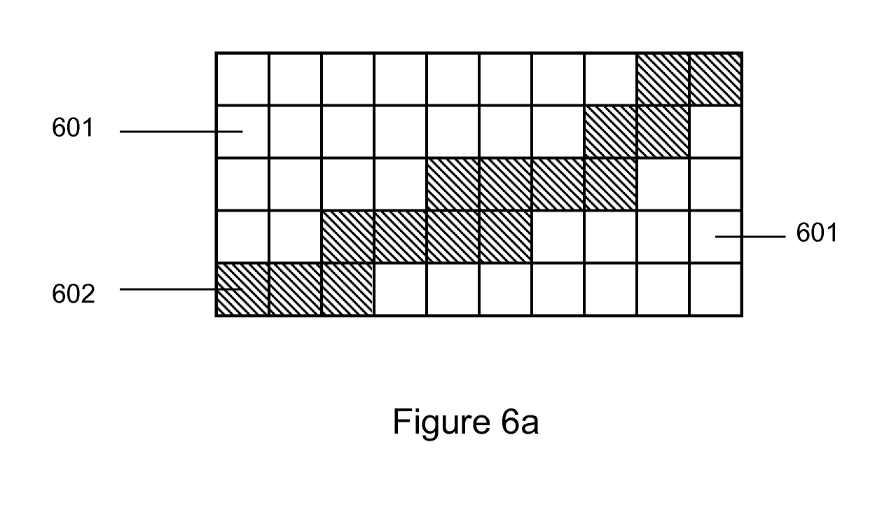

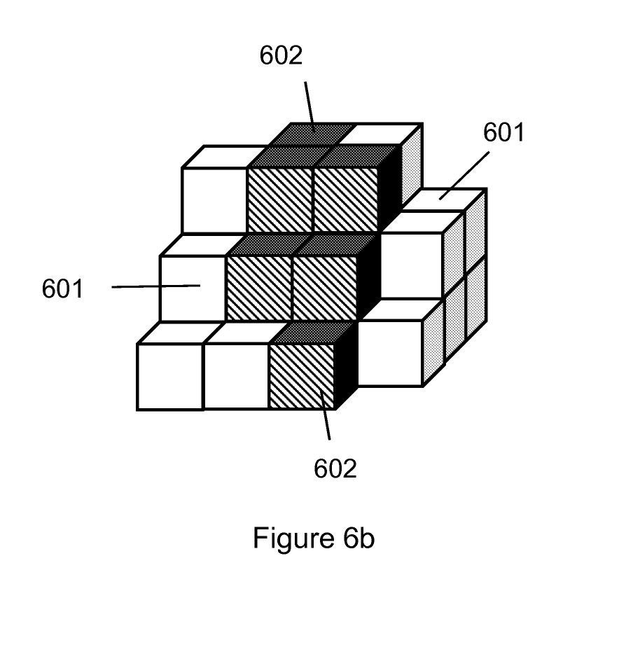

The image data 120 is sent by the system controller 110 to the data processing module 125. The data processing module 125 prepares the image data 120 for the building module 115 by breaking down the image data 120 into multiple layers of data with each layer comprised of voxels. FIG. 5 shows the image data of a 3D image sliced into multiple layers of data (500). FIG. 6a shows one such layer of data. Lattices 601 and 602 are voxels.

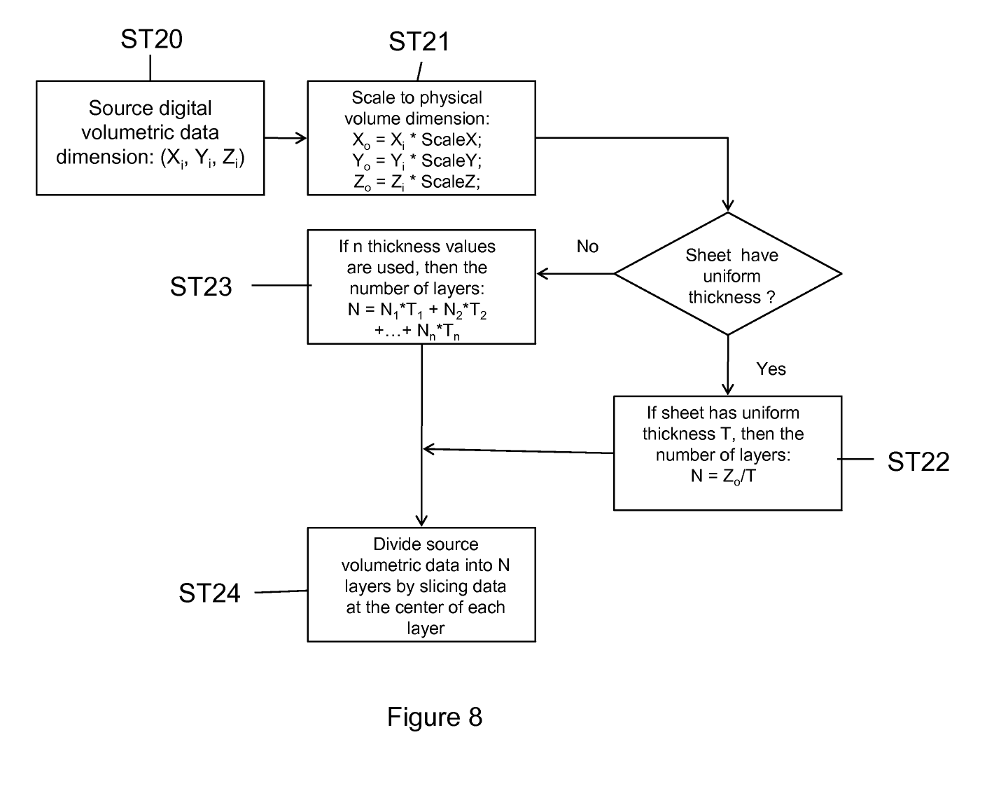

However to break down the image data 120 into multiple layers, the data processing module first needs to determine the total number of layers. The procedures are described below and depicted in the flow diagram in FIG. 8.

An input 3D image is defined by established coordinate systems such as the Cartesian coordinate system represented by (Xᵢ, Yᵢ, Zᵢ) shown in step ST20 of FIG. 8. Though the Cartesian system is used in this embodiment, it is easily imagined that other coordinate systems like polar, cylindrical and spherical may be used.

To translate the volumetric data to the desired size on the output device (Xₒ, Yₒ, Zₒ in device unit), the following formulas are used (step ST21 of FIG. 8):

Xₒ=Xᵢ*ScaleX;

Yₒ=Yᵢ*ScaleY;

Zₒ=Zᵢ*ScaleZ;

where ScaleX, ScaleY, and ScaleZ are the scalars for the three dimensions respectively.

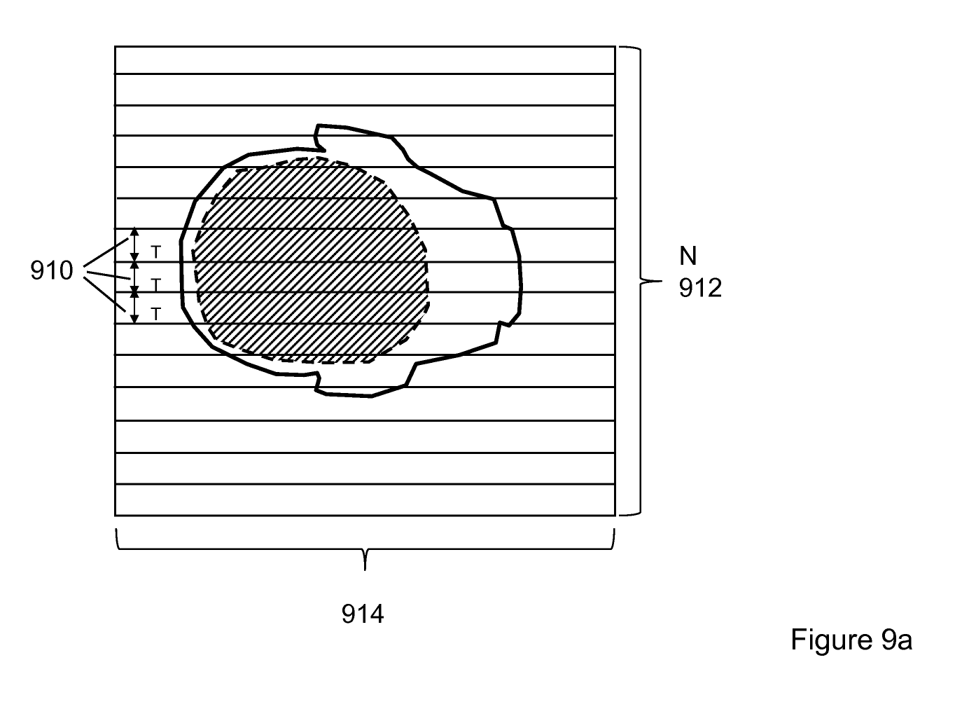

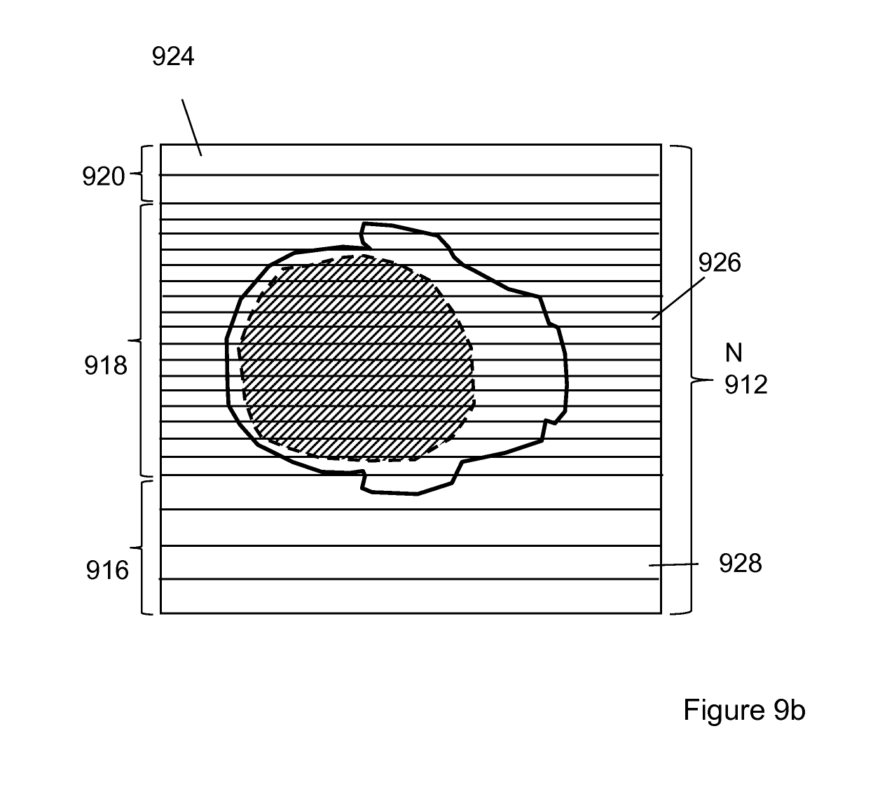

If sheets 131 (in FIG. 1) have uniform thickness and the same amount of adhesive is applied to each sheet, the total number of image layers N (912 in FIG. 9a) can be calculated as:

N=Zₒ/T;

where N is the total number of image layers (912 in FIG. 9a); Zₒ is a linear dimension of the volumetric image in device unit; and T (910 in FIG. 9a) is the thickness of the sheets 131 plus adhesive. This step is shown in step ST22 of FIG. 8. In FIGS. 9a and 9b, 914 and 915 refer to the length of the sheets in the x dimension.

If sheets of variable thicknesses are used as shown in FIG. 9b, the input image is first divided into sections, Z₁ (916 in FIG. 9b, Z₂ (918 in FIG. 9b), . . . , Zₒ (920 in FIG. 9b). The number of layers in each section is then calculated from the sheet thickness in that section as:

$${N}_{1} = {Z}_{1} / {T}_{1} ;$$

$${N}_{2} = {Z}_{2} / {T}_{2} ;$$

$$…$$

$${N}_{n} = {Z}_{n} / {T}_{n} ;$$

The total number of image layers 912 can then be calculated as:

$$N = {N}_{1} + {N}_{2} + … + {N}_{n} ;$$

where, N is the total number of image layers, n is the number of different sheet thicknesses, N₁, N₂, . . . , Nₙ are the number of layers used for each corresponding thickness, and T₁ (924 in FIG. 9b), T₂ (926 in FIGS. 9b), . . . , Tₙ (928 in FIG. 9b) are the sheet thicknesses used at each section. It is shown in step ST23 of FIG. 8.

The N image layers are then generated from the input data (ST24 of FIG. 8) using a three-dimensional image interpolation method, such as tri-linear or tri-cubic interpolation. Other interpolation methods such as nearest neighbor, simple averaging of neighbor voxels may be also used.

c) Definitions of Regions and Voxels:

During data processing, the image of each layer is divided by the data processing module 125 into different regions such as organs, bones, tumors, voids and other user defined regions. These regions are then marked with a boundary by a special algorithm. As shown in FIG. 5, an image layer 503 includes a 2D image separated into different regions 501 delineated by boundaries 502. Boundaries 502 comprise a set of voxels. At minimum, to create a continuous solid object, at least one non boundary voxel on a layer must share the identical location (x, y) with another non boundary voxel on an adjacent layer.

Each region 501 and each boundary 502 are broken down into voxels via computer algorithm. A voxel represents a volumetric unit in a 3D shape such as a cube, sphere or 3D polygon. Each voxel may be associated with one or multiple scalar values that indicate the characteristics at the location that the voxel represents. Data at each voxel can be derived from the image data 120. Data at a voxel may be constructed as a mathematical vector with components or scalars to indicate the properties at the location:

V(XYZ, COLOR, TRANSPARENCY, BOUNDARY, DUROMETER, . . . )

where XYZ is the position of the voxel; COLOR is represented by typical color models such as, RGB, CMYK, ASCII and the like; TRANSPARENCY is a scalar value between a range, for example 0 to 1 (0 as opaque and 1 as total transparent); BOUNDARY is a binary value that indicates if the voxel is on a boundary or not; and DUROMETER is represented by an array of scalar values further described below.

In some implementations, the parameter DUROMETER can be expressed using a set of two or more variables. In one particular implementation, to achieve varying durometer hardness at different voxels, two types of materials, A and B, may be used.

FIG. 6a illustrates a single layer of data comprising internal voxels 601 and boundary voxels 602.

FIG. 6b illustrates multiple layers of data with each layer comprising internal voxels 601 and boundary voxels 602.

Once the image data 120 is processed into layer and voxel data, the data processor 125 sends the processed data to the system controller 110. The system controller 110 converts the data into a set of commands that are sent to the 3D object building module 115 to control the building module 115 to create the 3D object 160.

d) Model Building

In referring to FIG. 1, the system controller 110 controls the building module 115. The building module 115 comprises various modules, parts, or devices, for example, the color controlling module 140, the durometer controlling mechanism 170, and the sheet assembly module 150, etc. Upon obtaining the cross-sectional image layer 500 from the data processor 125 the system controller 110 controls the operations of feeding the printing sheets 131 from the media cartridge 130, implementing colors in the regions 501 and boundaries 502 using the color controlling module 140, implementing durometer hardness using the durometer controlling mechanism 170, separating the regions using the mechanism 171 and forming the final object 160 in the assembly module 150 by binding all the printed sheets 132 together.

In this embodiment, the media cartridge 130 holds a stack of polyester (PET) sheets 131. Other materials such as nylon, polycarbonate, silicon, PVC, rubber, paper, water soluble paper, cotton and the like may be substituted. Sheets 131 may also be a composite material that is specially formulated with desirable properties to facilitate operations in the material handling, printing, detection and/or region separation steps. These properties or treatments may include but are not limited to: a layer of adhesive applied to a surface, a coating of Teflon to assist in the boundary separation step, hydrophobic or hydrophilic treatments that improve certain qualities of the final object, durometer of the material, transparency of the material, or a foam material with closed cell or open cell structure. The media cartridge 130 holds sheets 131. Sheets 131 are of uniform thickness and size in the media cartridge 130. A different cartridge 130 may contain sheets of a different size and/or thickness. The media cartridge 130 includes an information storage device 133 for storing information about the media cartridge 130, such as the following: lot number, status of the sheet cartridge (such as new or used), shelf-life, use-life, manufacturing date, sheet size, sheet thickness, sheet color, sheet transparency, sheet durometer, sheet coating, sheet structure (such as open or closed cell forms), sheet material, and number of sheets. It can also store sheet specific information that may helpful in other steps such as printing temperature, bonding temperature, bonding pressure, suitable inks (such as solvent ink, uv ink, water basked ink, etc.), the amount of ink to be applied, water/solvent amount to be applied, printing speed, boundary cutting method, and other parameters needed for optimizing the printing quality and/or speed. For example, a Dallas memory chip or a MID (Radio Frequency Identification) memory tag is used in this embodiment. The information in the memory tags may be selectively or continuously updated as necessary. For example, the number of sheets remaining in the media cartridge 130 may be updated during the printing process.

In this embodiment, sheets are of standard 8.5″×11″ size and every sheet in cartridge 130 is identical in size and thickness. In some implementations, the dimension and the thickness of the sheets may vary. If the size is different than 8.5″×11″, the information storage device 133 will store the appropriate information such that the module builder 115 can adjust its operations accordingly. Because it is a standard, readily available size, 8.5″×11″ is used but only as an example.

Each sheet 131 is extracted from the media cartridge 130, via typical motor controlled roller means such as those commonly found in desktop paper printing devices, and is transferred to the color controlling module 140.

The color controlling module 140 can be sized appropriately based on the size of the sheets 131 and can accommodate sheets of different sizes.

For purposes of demonstration, in this embodiment, the color controlling module 140 is an inkjet printing mechanism that is common to desktop inkjet printing technology. Other mechanisms can also be used, such as laser color printing, wax color printing, UV color printer, thermal transfer color printing, color plotter or other color printing variants known in the field. The color controlling module 140 includes a color printer head 141 for printing inks of mutually different colors. The art of inkjet printing is not described as it is commonly known. As shown in FIG. 5, these inks may be used to print the colored portion of each voxel in regions 501 and boundaries 502 in the cross-sectional image layers 503. Each voxel may be printed with a color based on the value (COLOR), which is derived from the initial image data 120. Once printing is complete, a printed sheet 132 is transferred by typical roller mechanisms to the sheet assembly mechanism 150.

The durometer mechanism 170 implements the scheme of varying durometer hardness. In this embodiment, varying durometer hardness is achieved through the epoxy method. In the following discussion, the common name epoxy is used. Other adhesives can be used to achieve varying durometer hardness as well. These include acrylic, silicon, rubber, and other petroleum based adhesives. As described previously, varying ratio of two epoxies, A and B, will yield varying durometer hardness. When two epoxies are used, the durometer controlling module 170 may include two dispensing mechanisms mounted above the work platform 155 to dispense epoxies on printing sheets. Dispensing mechanisms include inkjet, piezoelectricity system, micro pump, nozzle spraying, syringe, etc.

Either the work platform 155 or the dispense mechanism(s) or both can be mounted on a linear movement mechanism that moves in the XY plane (see FIG. 5) above the printed sheet 132.

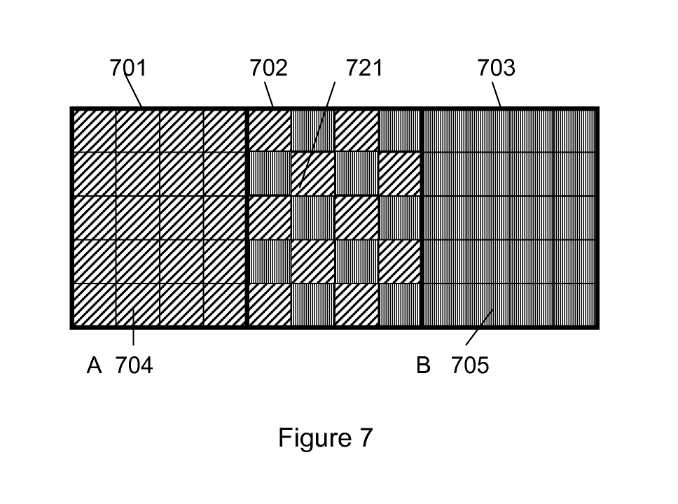

In FIG. 7, the region 701 is printed with epoxy A (704) and has a durometer hardness of a. The region 703 is printed with epoxy B (705) and has a durometer hardness of b. By applying epoxy A and epoxy B to different numbers of voxels within a certain region, any durometer hardness between the hardness a and the hardness b can be achieved. In the region 702, each voxel is printed with either epoxy A or epoxy B. For example, the parameter DUROMATER at the voxel 721 has a value of a, which indicates that material A is printed at that location. Because in the region 702 half of the voxels are printed with epoxy A (indicated as squares shaded with slanted lines) and half are printed with epoxy B (indicated as squares shaded with vertical lines), the region 702 has a hardness of (a+b)/2 or between a and b.

For simplicity, it is assumed that the smallest delivery resolution of the epoxy is one voxel. However, two or more voxels can be grouped as the smallest delivery resolution for epoxy delivery. Conversely, the volume delivery resolution of epoxy may be a fraction of a voxel.

Alternatively, each voxel may be printed with a mixture of epoxies A and material B to achieve varying durometer hardness. In such case, the DUROMETER component of variable V may be represented by a set of two values (α, β) with α representing the percentage of material A in weight or volume and β representing the percentage of material B in weight or volume in the mixture. During printing, when a mixture of materials A and B in the ratio of α:β is deposited at a voxel, the durometer hardness at that voxel can be expressed as (a×α+b×β). When the ratio of materials A and B deposited in one voxel is varied, the overall durometer of the region encompassing that voxel will vary. The ranges within which a ratio of materials A and B can be achieved is set by the dispensing capabilities of the dispense mechanisms. Each voxel may be printed with a varying combination of adhesives in varying ratios in order to simulate the durometer hardness and other mechanical properties derived from the initial image data 120. For simplicity, only two epoxies are described. However, a combination of three, four or more materials may be used to achieve different durometer hardness by applying the ratio method described above. These various materials may have not only additive properties, but also a deductive and/or chemical property such as the property possessed by an adhesive dissolver or solvent. When combined with materials A and/or B the material possessing a deductive property may weaken the structure or bond of the mixture deposited in the region of 702 to achieve certain durometer hardness.

Furthermore, the durometer hardness of the final product is determined by the mechanical properties of sheets 131, those of epoxy materials A and B, and the chemical/physical interactions between them. Just as materials A and B can be varied, material of sheets 131 may be varied to achieve a range of durometer, flexibility and other mechanical properties of the final product.

The previously described operations carried out in the color controlling module 140, the durometer controlling mechanism 170, the region separating mechanism 171 are not sequentially dependent. The printed sheet 131 can be printed first by the color controlling module 140 and then transferred to the sheet assembly module 150. Or the color controlling module 140 can be located in the assembly module 150 such that the coloring, curing, bonding, cutting steps are performed on a sheet that is stationary. The printing Step ST3a can also be done after the adhesive/epoxies have been deposited in Step ST4a. In this case, the adhesive/epoxies may still bond the layers 500 together after covering with printed color materials in the printing Step ST3a. Or an additional layer of adhesive will be applied on top of the printed color material to bond the layers 500 together. Mechanism 170 or similar mechanism can be used to apply this additional adhesive layer.

The cutting mechanism 143 is used to separate regions delineated by the boundaries 502. Cutting can occur after the sheet 132 is bonded to the model 160. In this embodiment, a laser is mounted above the work platform 155. The laser is controlled by two types of commands: 1) set at a power level to cut through only a single sheet 132 and 2) move to a certain location via a XY linear motion mechanism. Alternatively, the platform 155 can be moved in the XY plane to trace the boundaries 502. The art of controlling the laser to cut a certain thickness is not described as it is commonly known and is used extensively in industries. Although a laser is used in this embodiment, any continuous perimeter tracing method may be used to separate regions. As the name implies, continuous perimeter tracing method uses a point cutting device to trace the perimeters of a region. A point cutting device may be a sharp blade or a water jet that can be used to cut through the sheet materials.

The cutting mechanism 143 may be also used to make additional cuts in any area defined by the user or by the data processing module 125. Such a cut may help to remove the supporting materials that are no longer needed, or make it easier to separate different regions, or for other purposes.

The working platform 155 in the assembly mechanism 150 provides a platform to build the 3D model 160. The platform 155 receives sheets 132 from the media cartridge 130 or the color controlling module 140 and may be equipped to move along the Z direction to accommodate the increasing number of printed sheets 132 that are stacked on the platform 155 as layers are completed. The platform 155 is sized identically with the walls to fit the dimensions of sheet 131 such that alignment of current sheet 135 to object 160 is passive. A sensor 180 can provide continuous feedback to the system controller to adjust the platform 155 so that the top of the model 160 is always at a constant height as layers are added. The sensor 180 can be a typical surface height measuring sensor such as a laser distance measurement device. The sensor helps keep the top surface of the 3D model 160 at the same height for the various mechanisms to work on the current sheet 135. For the first sheet, the platform 155 employs a vacuum mechanism, and/or a small amount of adhesive to secure the sheet. For subsequent sheets 132 a heated roller mechanism 190 may be employed to press the new sheet onto the previous sheet that is already secured on the platform 155.

While sheets are being stacked on the platform 155, a bonding mechanism may be employed. The bonding mechanism is the same mechanism as the durometer controlling mechanism in this embodiment. The bonding can be achieved through curing of the epoxy, drying of glues, or fixing of adhesives,

The above described process is repeated for each sheet until the model 160 is completed. Once the final sheet is placed on the stack and the appropriate epoxy curing time has elapsed, the model is ready for use. In the model, the user will find different color and durometer attributes on cut-through cross sections. The user can also remove parts of interest for separate examination. Because each 2D region has been separated on each layer, the stacked up 3D region of these 2D regions can also be separated from other regions.

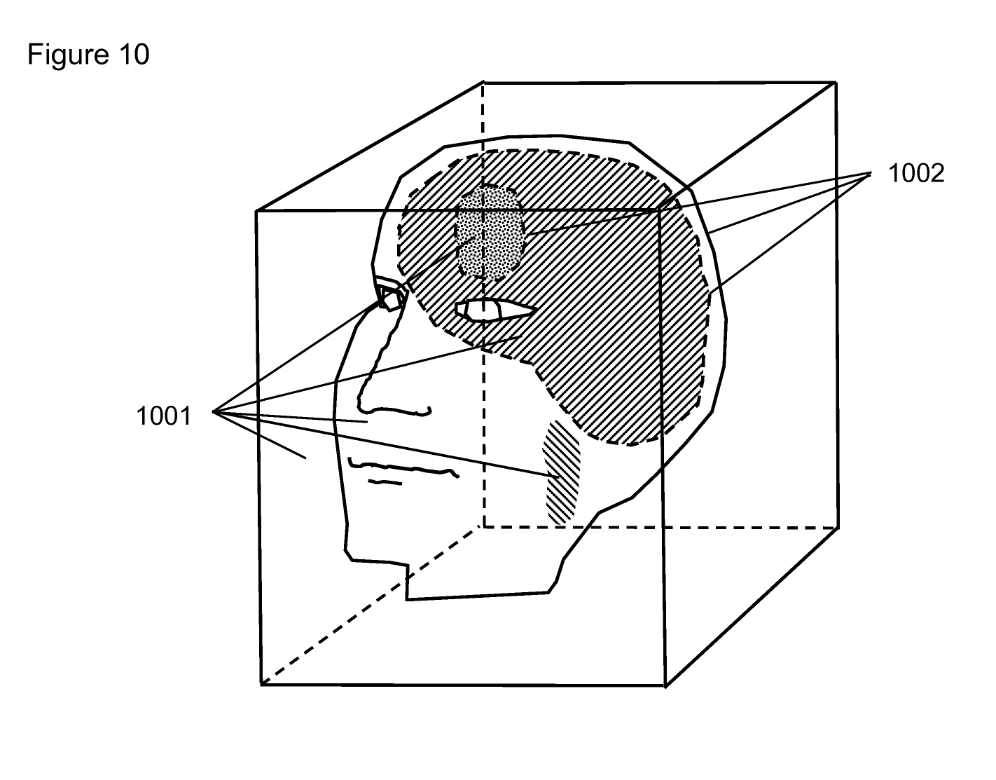

FIG. 10 shows a finished 3D model of a human head. The internal features shown as shaded regions 1001 in FIG. 10 include the brain, the frontal lobe, and the back of the throat of the head that may be of interests to a doctor. The boundaries 1002 segregate one internal region from another. If the doctor is interested in learning more about a particular region, for example, the frontal lobe, he can cut a cross-section through the frontal lobe and study that region. He can also take that particular organ out of the model for separate examination and put it back into the model after he has finished.

e) Other Features

In the first embodiment described above, many modules, mechanisms, or devices can be modified or adapted for different applications.

For example, in one implementation, the sheets 131 may be stored in a continuous roll rather than in a stack. The media cartridge 130 contains a cutting mechanism similar to the separation mechanism 143 as shown in FIG. 1. The cutting mechanism may be used to cut a new sheet from the roll once a previous sheet is completed.

In another implementation, a disposable tray (not shown) is placed on the working platform 155 and secured via mechanical means such as screws or latches. This disposable tray is sized to and has walls that match with the size of sheets 131 in the media cartridge 130. This feature allows for a quick change of object sizes between printing tasks because in this way multiple cartridges that can hold sheets of different sizes may be used.

In some implementations, sheets 131 are stacked on the 3D model 160 via an active feedback mechanism. This feature requires that each sheet in the media cartridge 130 be printed with fiducial markings (not shown). A printed sheet 132, referenced by the fiducial markings and verified by the optical sensor 180, can be placed precisely at the same location as the previous sheet. This feature improves the stack up tolerance of the model 160 as an increasing number of sheets 132 are added to the model 160.

In another implementation, instead of the continuous parameter tracing methods, the cutting mechanism 143 may use the closed perimeter methods. A closed perimeter method employs certain types of solvent and solvent resistant ink. In referring to FIG. 5, on the sheet 503, the regions 501 will be printed with the solvent resistant ink. The boundaries 502 will be free of such ink. The solvent is then applied to the entire sheet. Where there is no solvent resistant ink, the solvent will dissolve the sheet material. This method can separate regions by breaking multiple points of the gap between regions at the same time.

In yet another implementation, instead of using epoxy, the durometer controlling mechanism 170 dispenses a UV curable material. The duration of UV exposure determines the durometer hardness of the material after curing.

In a different implementation, sheets 131 are pre-applied with an adhesive. As the printed sheet 132 is transferred to the assembly module 150, the side of the sheet 132 with adhesive is facing up in the z axis (FIG. 5). The roller 190 is coated with Teflon to resist adhesion and is used to press the current sheet 135 to the model 160. Before a new sheet is assembled, an anti-glue mechanism (not shown) dispenses an anti-glue substance to areas where adhesion is not desired.

In another implementation, the color controlling module 140 employs a thermal sheet technology to implement the color regions 501 and boundaries 502. For purposes of demonstration, ZINK Paper™ from ZINK Imaging Inc. may be used. When heat is applied to a piece of ZINK Paper™ appropriately, full color images appear on the paper. This art is described in U.S. Pat. No. 6,906,735 and will not be detailed in this disclosure. In this implementation, a special 2D printer 140 is needed. For purposes of demonstration, the Polaroid PoGo™ printer from Polaroid is used. In this implementation, the color controlling module 140 may be a simple mechanism that transfers sheets from the media cartridge 130 to the building module 150.

In some implementations, a type of special adhesive may be used. The durometer mechanism 170 dispenses one or more adhesive materials, including the special type of adhesive. This special type of adhesive will hold the layers together. But after curing or drying up, the model layers can be separated and then be assembled back together. One example of this type of adhesive is 3M Spray Mount Repositionable Adhesive. This feature is very useful in applications such as 3D medical models. Doctors can check a particular area by slicing the model open along the glued layer and examine the detailed internal features. After the exam, the model can be assembled back together with the help of the repositionable adhesive.

In some implementations, instead of adhesives, magnetism may be used to bond layers together. Each printing sheet may be covered with a layer of magnetic coating or be made of magnetic film. This feature is useful in applications such as medical 3D models. Doctors can check an area of interest by temporarily slicing the model open along a layer and examine the detailed internal features. After the exam, the model can be assembled back together.

In some implementations, instead of adhesives and magnetism, mechanical methods may be used to hold layers together. The mechanical methods used can be: screws, binder clip, rubber band, or other similar methods which can hold all the layers together. Doctors can check an area of interest by temporarily opening along a layer and examine the detailed internal features.

In one implementation, colored fluorescent inks may be used for printing. Fluorescent inks can be used to highlight certain features such as blood vessels or bones in a 3D medical model and make those features more salient or visible.

### (2) Second Embodiment

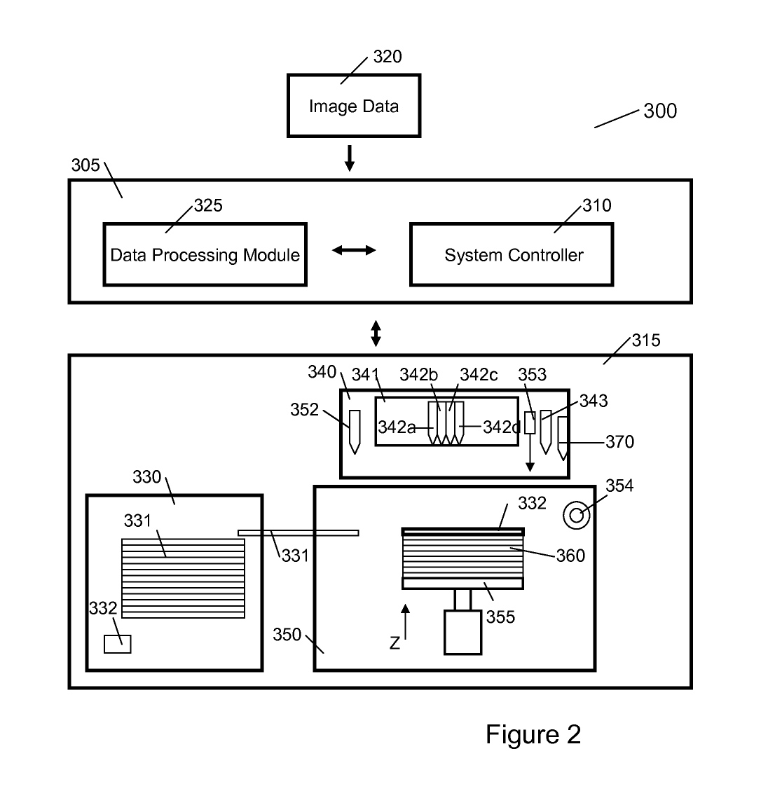

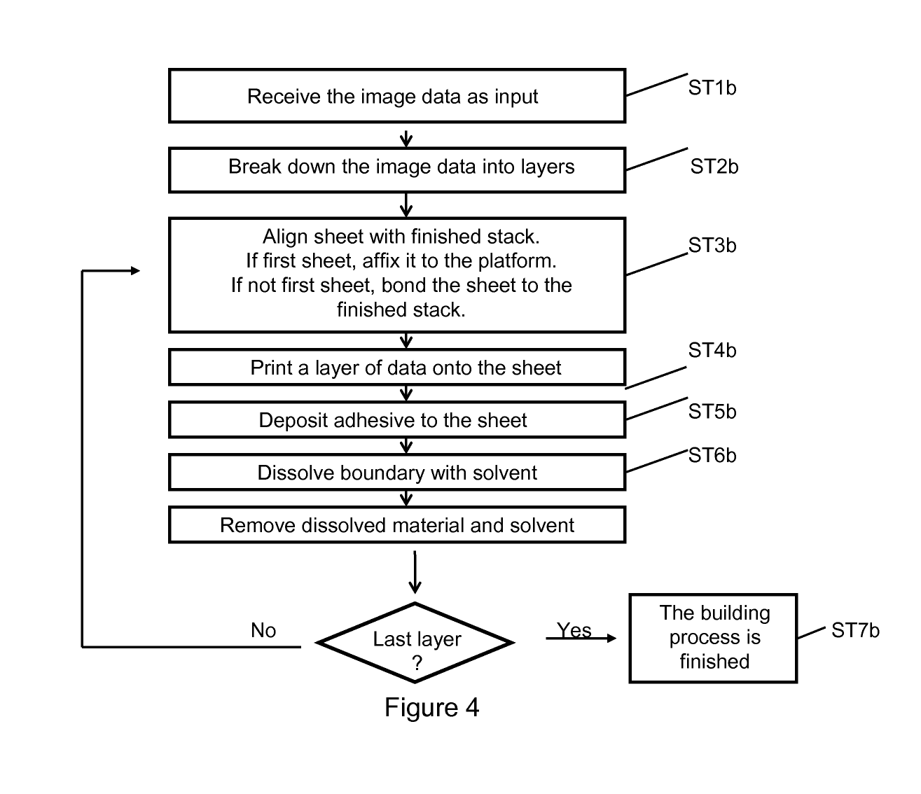

FIG. 2 illustrates a second embodiment of a 3D printing apparatus. FIG. 4 is a flow chart showing the basic operations of this embodiment which employs a solvent-based boundary removal mechanism.

Similar to the first embodiment, the system controller 310 sends the image data 320 to the data processing module 325 (Step ST1b in FIG. 4). The data processing module 125 converts the image data 320 into cross-sectional image layers 500 (shown in FIG. 5) by slicing the three-dimensional image data 320 in a predetermined direction and layer thickness (Step ST2b in FIG. 4). The data of an image layer 500 includes image data used for coloring the voxels on the layer, image data used for defining the transparency of the voxels on the layer, image data used for defining the durometer hardness of the voxels on the layer, image data used for specifying the type of adhesives to be used and the quantity to be applied to the voxels on the layer and the boundaries. The image regions 501 are a region of the object to be colored and the boundary regions 502 is a region not to be colored for later separation of adjacent regions. Each voxel in a color image region may be colored with different colors that are dictated by the original 3D image data 320. Each voxel in the color image region can have different hardness according to original 3D image data 320. The data processing module 325 sends the cross-sectional image layers 500 back to the system controller 310. The system controller 310 outputs these data to the 3D model building module 315 and controls the building module 315 to build a 3D model 360 layer by layer (Steps ST3b-ST7b).

As shown in FIG. 2, the sheet cartridge 330 and sheets 331 are similarly oriented as in the first embodiment. Sheets 331 are made of a type of solvent-susceptible material. For purposes of demonstration, water is used as the solvent in this embodiment, and sheets 331 are made of water soluble paper. The art of water soluble paper is well known and will not be detailed in this embodiment.

In FIG. 3, sheets 331 are printed and laminated on the working platform 355. The method and processes for this embodiment are discussed below in detail.

a) The Laminating and Bonding Process,

A blank sheet 331 is transferred to the top of the working platform 355. If the sheet is the first sheet, it is placed on the working platform 355 and is affixed to the platform per methods previously mentioned (Step ST3b in FIG. 4).

Subsequent sheets are fixed to the block 360 with roller (Step ST3b in FIG. 4). Appropriate amount of pressure may be used to bind adjacent sheets together. Heat may also be used in the process. For example, the roller 354 may be heated if heat activated adhesives are used.

Also included in the assembly module 350 is the working platform 355 for providing a platform to build the block 360. A surface height measurement device 353 may be used to control the surface height of the block 360 to keep it at a constant level. The surface height measurement device 353 may be a laser height measurement device or the like. The information of the downward travel distance of the working platform 355 at a certain cross-sectional image layer 500 will be used to recalibrate the number of sheet 331 required to build the remaining part of the 3D object determined by data processing part 325. The total number of sheets is determined by the number of layers determined by the data processing module 325.

b) The Image Printing Process

The 2D printer 340 includes a color printer head 341 for printing inks of mutually different colors. Specifically, the inks are in the colors of C (cyan) (ink tank 342a), M (magenta) (ink tank 342b), Y (yellow) (ink tank 342c), K (black) or W (white) (ink tank 342d). Print head with inkjets can be used for delivering the inks in the ink tanks 342a, 342b, 342c and 342d. A preferred inkjet may be the piezoelectricity type printer. When these inks used in the ink tanks 342a, 342b, 342c and 342d are wax based color inks, the color printer head 341 may be heated to a temperature several degrees higher than the melting temperature of the wax ink used. As shown in FIG. 5. these inks are used to print the colored regions 501 in the image layers 500. When wax ink is applied on a blank sheet 331, the printed areas 501 of a printed sheet 332 become water resistant or water proof because of the water resistant property of the wax ink.

Other water proof inks, such as UV curable inks, epoxy based inks, silicone based inks, may be used. Non water resistant inks or methods (such as laser printer, color plotter or other color printing variants known in the field) may also be used for printing. When non water resistant inks are used, a layer of water proof coating can be printed on the areas requiring waterproof properties before or after the color inks have been deposited on the sheet.

In this embodiment, sheets made of water soluble paper are used here. Sheets can be made of other solvent soluble materials as well.

Either the color printer 341 or the platform 355 may be mobile along x and y directions to allow the printer to cover the entire sheet 313. The height of the printer head may be fixed at the same z position. In such case, the working platform 355 will be movable.

c) Adhesive Printing Process

An adhesive printer 370 can dispense binding materials in areas where the colored regions 501 overlap with the adjacent layers for binding the adjacent layers together. Two binding materials with different durometer hardness can be delivered as shown in FIG. 7 and explained in the first embodiment section. More than two binding materials may be used to achieve the durometer variations in different areas. Each voxel may be printed with different adhesives or a combination of different adhesives to simulate the hardness and other mechanical properties indicated in the initial image data 320.

Depending on the resolution of the adhesive printer 370 and the size of each voxel, multiple dots of different adhesives or single dot of one adhesive can be applied in one voxel, a fraction of a voxel or two or more voxels depending on the hardness requirements of the regions 501.

In FIG. 7, two different adhesives are applied to different locations. They can also be applied to the same location with different ratios to achieve different hardness. In this implementation, the adhesives are used for two purposes, binding and generating different durometer hardness.

The adhesive printer part 370 may include inkjet, piezoelectricity system, micro pump, nozzle spraying, syringe, etc.

d) Marking Boundaries with Solvent

The 2D printer module 340 also includes a solvent dispenser 343 for dispensing solvent to the boundaries 502. In this example, water is used as solvent and the sheets are made of water soluble material. The solvent dispenser 343 can be inkjet dispenser, nozzle dispenser, or spray dispenser, or other types of dispensers.

The solvent dispenser or the work platform may be mobile to allow solvent to be deposited at every location on the sheet 332.

e) Removing the Boundaries

A vacuum head 352 is used to remove unwanted materials along the boundaries 502 on the printed sheet 332. It can be a simple nozzle that is controlled by a controller and can move along the boundary in the x-y plane. Alternatively the vacuum head 352 may span the width of the printed sheet 332 and can move along the length of the printed sheet 332.

For this purpose, a roller with a sticky surface can also be used to pick up the weakened or dissolved boundary materials. The sticky surface will be cleaned after each layer.

Though water is used as the solvent and water soluble paper as the printing sheets, it can be easily imagined that another combination of media—solvent and solvent resistive ink and/or coating may be applied in a similar manner to achieve the same results.

The aforementioned process is repeated for each layer until the model is complete.

### (3) ‘Z Corp’ Embodiment

This embodiment incorporates the data processing module disclosed in the first embodiment section and uses adhesive and powder to build 3D models. In this embodiment, a 3D model is built selectively by applying a binding or multiple binding liquids to incremental layers of powder. The binding liquids bind layers of the powder to form solid two-dimensional cross sections of the model. This art is publicly disclosed and the technology is implemented in Z Corporation's 3D printers.

To achieve varying durometer hardness, an adhesive printer can dispense binding materials in the colored regions 501. Two binding materials can be delivered as shown in FIG. 7. Durometer hardness of the final object can also be controlled by selecting powders of different hardness. The combination of different adhesives and powders used determines the hardness of each voxels in the 3D model.

To achieve varying colors in different regions 501, a 2D printer that includes a color printer head such as the color printer head 341 in FIG. 2 for printing inks of mutually different colors may be used to print colors on solid cross-sections. Printer heads with inkjets can be used for delivering the inks in the ink tanks such as the ink tanks 342a, 342b, 342c and 342d as shown in FIG. 3.

### (4) ‘Object Geometries’ Embodiment

In this embodiment a liquid-based polymer material is used to build a 3D model. The 3D model can be formed by feeding liquids, such as photopolymer, through an inkjet-type printer head onto each layer of the model. As implemented in Photopolymer Phase machines, an ultraviolet (UV) flood lamp can be mounted in the printer head to cure each layer as the building liquids are deposited. This technology is used in 3D printers manufactured by Object Geometries Ltd.

To achieve different durometer hardness, two photopolymer materials with different curing durometer hardness may be delivered as shown in FIG. 7. One photopolymer material will he soft (low durometer Scale OO 15) after curing. The other photopolymer material will be hard (durometer Scale D 75) after cure.

To implement color at voxel level, a 2D printer inkjet printer dispensing UV ink may be used after each layer of liquid polymer material is dispensed. After each layer, UV light may be used to cure the ink and the polymer material at the same time. The color ink may also be delivered and cured after the polymer material is deposited. The ink may also be a solvent based ink that may be cured over time and through air exposure.

In a different implementation, the photopolymer material used for model building is a composite blended with ZINK™ crystals. Each composite particle consists of a core with the cyan, yellow, and magenta ZINK™ crystals embedded inside a protective polymer overcoat. The core of a composite particle can be paper or other materials. Hardness of the core can be varied to achieve the desired hardness for the 3D model. Materials such as polyurethane, silicon rubber can be used for the core. The completed model when exposed to targeted heating with varying temperatures and durations, will show different colors at each voxel because of the colored crystals deposited at the voxel. When appropriate heating is applied, full color images may appear.

### (5) ‘SLA’ Embodiment

This embodiment uses existing Stereo-lithography (SLA) technology coupled with typical 2D color printing technologies to create 3D models with colors. SLA is an additive manufacturing process using a vat of liquid UV curable resin and a UV laser to build up the model one layer at a time. On each layer, a laser beam traces a cross-section pattern on the surface of the liquid resin. Exposure to the UV laser light cures or solidifies the pattern that has been traced on the resin and binds it to the layer below. After the pattern at one layer has been traced, the SLA's elevator platform descends by a depth that equals to the thickness of a single layer. Then, a resin-filled blade sweeps across the entire cross section, re-coating it with a layer of fresh material adhering to the previous layer. On this new liquid surface, the pattern of the subsequent layer is traced. This technology is implemented in 3D printers manufactured by 3D systems, Inc.

In this embodiment a 2D dispensing color printer is mounted on the same axis or a different axis apparatus as the UV laser beam and prints color on each layer. When the building process is completed, a cross section of the object will show colored details at each voxel location. The color printer may be a UV type, solvent type, laser printer or other well known color printing devices.

### (6) FDM Embodiment

In this embodiment, fused deposition modeling (FDM) technology is combined with material adaptation methods to build 3D models with varying durometer hardness and colors.

The FDM method uses molten polymer materials to build 3D models. As demonstrated in FIG. 7, different molten materials can be combined to yield different durometer hardness at different voxels. One type of photopolymer material will be soft (low durometer Scale OO 15) after curing. The other photopolymer material will be hard (durometer Scale D 75) after curing. To achieve varying durometer hardness, a mixture of both molten polymer materials is delivered at different voxels. As the ratio of these two materials and changes, the final hardness may be changed. More than two molten polymer materials may be used to achieve the durometer variations in different regions. Each voxel can be printed with different molten polymers or different combinations of molten polymers to simulate the hardness and other mechanical properties according to the initial image data.

In this embodiment, a 2D color printer is mounted to print colors on each layer. When the model is completed, a cross section of the object will show colored details at each voxel location. The color printer may be a UV type, solvent type, inkjet type, laser printer type, plotter type or other color printing variants known in the field.

Although the description above contains many details, these should not be construed as limiting the scope of the invention but merely as providing illustrations of some of the presently preferred embodiments of this invention. Therefore, the scope of the present invention is understood to fully encompass other embodiments which may become obvious to those skilled in the art. In the appended claims, reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present disclosure. Moreover, it is not necessary for a device or method to address each and every problem sought to be solved by the present invention, for it to be encompassed by the present disclosure. No claim element herein is to be construed under the provisions of 35 U.S.C. 112, sixth paragraph, unless the element is expressly recited using the phrase “means for.”

A number of embodiments of the invention have been described. Nevertheless, it will be understood that various modifications may be made without departing from the spirit and scope of the invention. For example, some of the steps described above may be order independent, and thus can be performed in an order different from that described.

It is to be understood that the foregoing description is intended to illustrate and not to limit the scope of the invention, which is defined by the scope of the appended claims. For example, a number of the function steps described above may be performed in a different order without substantially affecting overall processing. Other embodiments are within the scope of the following claims.

What is claimed is:

1. A method of building a 3D model, comprising:
receiving image data as input, said image data being a 3D image of the 3D model;
processing the image data to break down the 3D image into two or more layers wherein processed data of each layer contain attribute information of the 3D model that includes color and hardness;
printing the processed data of each layer onto a printing sheet and depositing one or more selected materials onto the printed sheet as dictated by the processed data of each layer;
preparing and binding the printed sheet into a stack;
continuing the printing and the preparing and binding steps until the processed data of a last layer has been printed onto a last sheet and the last sheet has been assembled into the stack;
finishing the 3D model by removing any excessive material from the 3D model.

2. The method of claim 1, wherein the image data is in a hybrid data format.

3. The method of claim 1, wherein the one or more selected materials are mixed before being deposited onto the printed sheet.

4. The method of claim 1, wherein the one or more selected materials are not mixed and are deposited separately onto the printed sheet.

5. The method of claim 1, wherein the preparing of the printed sheet includes collating and assembling.

6. The method of claim 5, wherein the preparing of the printed sheet includes curing of the one or more selected materials deposited on the printed sheet.

7. The method of claim 6, wherein the curing includes pressing the printed sheet with a heated roller.

8. The method of claim 6, wherein the curing includes exposing the printed sheet with UV light.

9. The method of claim 1, wherein the preparing of the printed sheet includes cutting through a boundary on the printed sheet.

10. The method of claim 1, wherein the processing of the image data includes calculating how many layers of processed data based on material properties of the printing sheet and the one or more selected materials.

11. The method of claim 1, wherein the one or more selected materials include a type of repositionable adhesive for easy dissembling and reassembling of the 3D model.

12. The method of claim 1, wherein the printing sheet has built-in magnetism for easy dissembling and reassembling of the 3D model.

13. The method of claim 1, wherein the processed data of one or more layers are printed on with florescent inks.

14. A 3D printing apparatus that is used to build a 3D model, comprising:
a data processing module for processing image data of the 3D model and for breaking down the image data into processed data of two or more layers with the image data being a 3D image of the 3D model;
a system controlling module for controlling the 3D printing apparatus;
a media cartridge for holding printing sheets;
a building module for printing, preparing, assembling, and binding printed sheets into a stack and for finishing the 3D model after the stack is completed.

15. The apparatus of claim 14, further comprising an information storage device to store information about the media cartridge.

16. The apparatus of claim 15, wherein the information stored in the information storage device comprises the size information of the printing sheets.

17. The method of claim 16, wherein the building module comprises a printer for printing the processed data of the two or more layers onto the printing sheet.

18. The method of claim 17, wherein the building module further comprises a mechanism to transfer a printing sheet from the media cartridge to the building module.

19. The method of claim 18, wherein the building module further comprises a working platform to hold the 3D model while it is being built.

20. The method of claim 19, wherein the building module further comprises a dispensing mechanism for depositing one or more selected materials onto printed sheets to yield different durometer hardness.

21. The method of claim 20, wherein the one or more selected materials are epoxies.

22. The method of claim 20, wherein the one or more selected materials are solvent-resistant ink.

23. The method of claim 21, wherein the building module further comprises a cutting mechanism for cutting through boundaries of the 3D image.

24. The method of claim 22, wherein the building module further comprises a solvent dispense mechanism for dispensing solvent to remove parts of the printed sheet on which the solvent-resistant ink has not been deposited.

25. The method of claim 22, wherein the building module further comprises a distance sensing device for controlling positions of the working platform.

26. A 3D object builder for building complex objects derived from 3D hybrid data, comprising:
a media holder that includes a plurality of media, a media holding feature, a memory device wherein the memory device includes data regarding media details and security and wherein said media are of uniform dimensions to all media in the holder;
a mechanical mechanism that moves media from the media holder to a work area;
a means to implement a plurality of colors at each volumetric location of the 3D object while the media is in the work area, wherein the means to implement a plurality of colors is a typical color printing method attached to a 3D object builder such that the printer may deposit a plurality of color at each volumetric location in the 3D object that is being printed;
a means to implement a plurality of durometer hardness at each volumetric location of the 3D object while the media is in the work area, wherein the means to implement a plurality of said durometer hardness include materials in conjunction with chemical, curing and heating means; and
a means to build a plurality of objects within the 3D object all derived from said native hybrid data wherein the means to implement a plurality of objects derived from said data files is by distinguishing regions in each cross sectional layer of the 3D object and separating each of said regions in each cross section during the 3D object building process where the thickness of said cross sectional layer is dependent on the thickness of the media used to build the 3d object.
